(19) United States
(12) Patent Application Publication
(10) Pub. No.: US 2019/0053145 A1
(43) Pub. Date: Feb. 14, 2019

(54) RADIO COMMUNICATION DEVICE AND METHOD FOR CONTROLLING SAME

(71) Applicant: KYOCERA CORPORATION, Kyoto (JP)

(72) Inventors: Yuuma IESHIRO, Rittou-shi, Shiga-ken (JP); Daisuke MORI, Yokohama-shi, Kanagawa-ken (JP)

(73) Assignee: KYOCERA CORPORATION, Kyoto (JP)

(21) Appl. No.: 16/077,413

(22) PCT Filed: Feb. 16, 2017
(86) PCT No.: PCT/JP2017/005782

§ 371 Date: Aug. 10, 2018

(30) Foreign Application Priority Data
Feb. 18, 2016 (JP) 2016-029249

(51) Int. Cl. H04W 48/18; H04W 48/16; H04W 76/11; H04L 5/00; H04W 12/08

(52) U.S. Cl. CPC H04W 48/18; H04W 48/16; H04W 72/0453; H04L 5/0094; H04W 12/08; H04W 76/11

(57) ABSTRACT

Provided is a radio communication device including a storage unit (30) that stores identification information for identifying a service area of a home network to which a user subscribed originally, a communication unit (20) that performs radio communication by using a frequency band of a radio communication method, with which the radio communication device (100) of a user is compatible, and a control unit that, at a time when a search for the frequency band of the radio communication method is performed using the communication unit (20) or before the search is performed, performs the search with excluding a roaming frequency hand, in which roaming is possible, from the frequency band of the radio communication method if the identification information stored in the storage unit (30) matches identification information acquired from a base station.

### TECHNICAL FIELD

This disclosure relates to a radio communication device that searches for a frequency band of a radio communication method, with which the radio communication device is compatible, and a method for controlling the same.

### BACKGROUND ART

Patent literature 1 discloses a mobile terminal that writes at least one of networks of an operator which is placed in a table held in advance in a SIM or a USIM, selects a cell of a network corresponding to the network written in the SIM or the USIM among networks detected by a cell search, and performs position registration.

### CITATION LIST

### Patent Literature

[Patent Literature 1]: Japanese Unexamined Patent Application Publication No. 2012-134766

### SUMMARY

### Technical Problem

However, in a method disclosed in Patent Literature 1, since a cell search is performed for all networks (2G and 3G), there is a problem that much power is consumed due to the cell search.

An object of this disclosure is to perform an efficient frequency search.

### Solution to Problem

A radio communication device of an example includes a storage unit that stores identification information for identifying a service area of a home network to which a user subscribed originally, a communication unit that performs radio communication by using a frequency of a radio communication method, with which the radio communication device of the user is compatible, and a control unit that, at a time when a search for the frequency band of the radio communication method is performed using the communication unit or before the search is performed, performs the search with excluding a roaming frequency hand, in which roaming is possible, from the frequency band of the radio communication method if the identification information stored in the storage unit matches identification information acquired from a base station.

### BRIEF DESCRIPTION OF THE DRAWINGS

FIG. 1 is a block diagram illustrating a radio communication device according to an embodiment.

FIG. 2 is a diagram illustrating a control flow of a radio communication device according to the embodiment.

FIG. 3 is a diagram illustrating a control flow when a radio communication device according to the embodiment is connected to a base station.

FIG. 4 is a diagram illustrating a control flow of a radio communication device according to the embodiment.

FIG. 5 is a diagram illustrating a control flow of a radio communication device according to the embodiment.

FIG. 6 is a diagram illustrating a frequency band available by a radio communication device in a certain radio communication method.

FIG. 7 is a diagram illustrating a state in which a radio communication device according to the embodiment is not located in a HPLMN communication service area.

### DESCRIPTION OF EMBODIMENTS

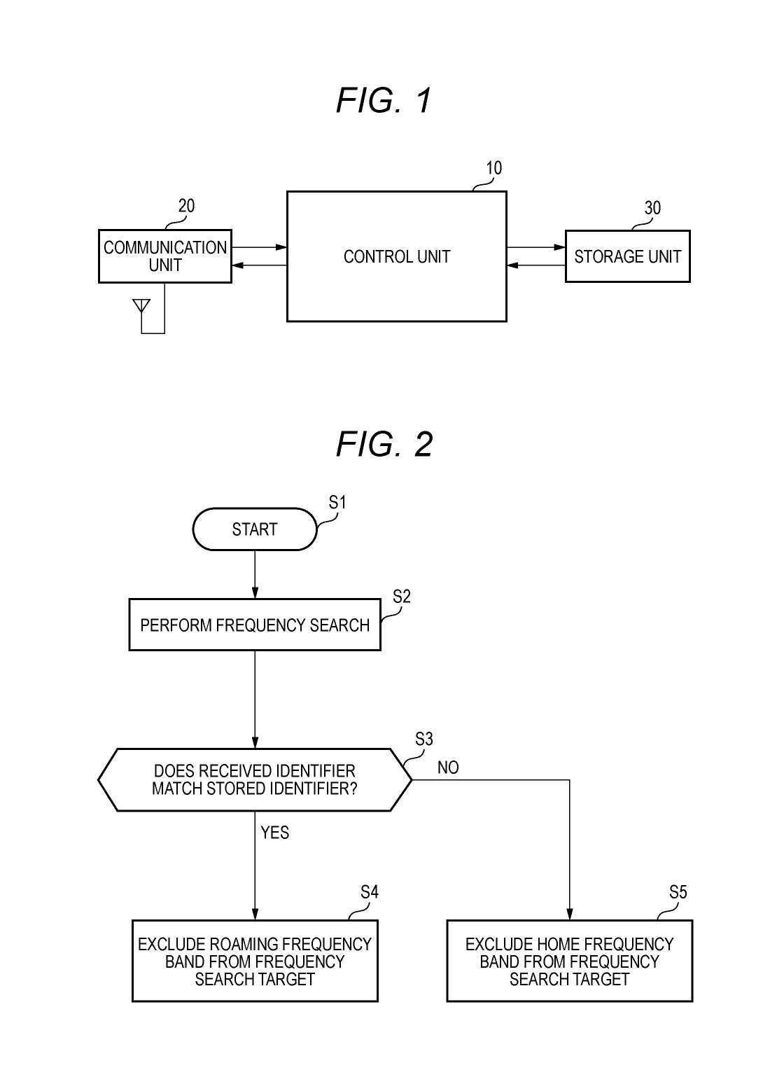

FIG. 1 is a block diagram illustrating a function (a configuration) of a radio communication device 100 in an embodiment.

The radio communication device 100 includes at least a control unit 10, a communication unit 20, and a storage unit 30. The radio communication device 100, for example, may further include any one of a display unit (a display), an operating unit, a camera, various sensors, an operating unit (a user interface), a microphone, a speaker, a receiver and the like. Furthermore, the radio communication device 100 may further include an insertion unit, into which a subscriber identity module (SIM) card (a universal subscriber identity module (U-SIM), a user identity module (UIM) and the like) is insertable, an interface that acquires information from the inserted SIM card, and the like, wherein the SIM card stores information (international mobile subscriber identity (IMSI), a telephone number and the like) on a subscriber (a user) who has made a contract with an operator (a communication provider).

The control unit 10 is controllably connected to the elements (the communication unit 20 and the storage unit 30) of the radio communication device 100 in a wired or wireless manner. For example, the control unit 10 transmits a signal (a control signal, data and the like) to the communication unit 20, and the communication unit 20 having received the signal performs transmission and reception of the signal (data and the like) with a base station via an antenna. When performing a predetermined process, the control unit 10 reads various programs and data stored in the storage unit 30 and performs writing and the like of data for the storage unit 30. The control unit 10 may be at least one CPU or chipset.

The communication unit 20 performs signal transmission and reception with the base station by using a predetermined frequency or a predetermined frequency band (800 MHz, 2 GHz and the like). Then, the communication unit 20 can demodulate a signal received from the base station via the antenna, output the processed signal to the control unit 10, modulate a signal input from the control unit 10, and transmit the modulated signal to another radio communication device via the antenna. Furthermore, the communication unit 20 may be compatible with various radio communication methods such as code division multiple access (CDMA2000), wideband code division multiple access (W-CDMA), and long term evolution (LTE), or may perform communication by any communication method selected by the control unit 10. When a frequency search is performed, the communication unit 20 is configured to receive information (for example, an identifier and the like of the operator) from the base station. The frequency search will be described later.

The storage unit 30, for example, includes a working memory and is used for an calculation process by the control unit 10. Furthermore, the storage unit 30 stores various programs and the like according to the embodiment. Furthermore, the storage unit 30 may be a random access memory (RAM). Furthermore, the storage unit 30 may be configured as a part of the CPU or configured as a memory separately from the CPU.

Furthermore, the storage unit 30 stores information (international mobile subscriber identity (IMSI), a telephone number, the identifier of the operator with which the user has made a contract, and the like) of the user who has made a contract with the operator. The identifier of the operator is a number of a public land mobile network (PLMN), and includes an identifier (a mobile country code (MCC)), which indicates a service area of the operator with which the user of the radio communication device 100 has made a contract, and a network code (a mobile network code (MNC)) managed by the operator. The information of the user may be stored in advance, or may be acquired from the SIM card inserted into the radio communication device 100 and stored.

Furthermore, the storage unit 30 stores an interval (a home public land mobile network (HPLMN) search interval) from an execution time point of a frequency search or a time point at which the radio communication device 100 has waited in a specific base station, to the start of a search of a HPLMN which is a network of the operator to which the user of the radio communication device 100 has originally subscribed. The frequency search interval stored in the storage unit 30 has at least two types of a normal interval (a first time) and an interval (a second time corresponding to the HPLMN search interval) shorter than the normal time.

Furthermore, the storage unit 30 stores each frequency band managed by the operator with which the user has made a contract. Moreover, the storage unit 30 may store a frequency band managed by another operator having a partnership with the operator, in addition to each frequency band. The storage unit 30 may store a frequency band managed by each country.

Next, a control flow of the radio communication device 100 according to the embodiment will be described using FIG. 2.

First, when a predetermined state is detected (step S1), the radio communication device 100 performs a frequency search (step S2). The predetermined state, for example, may be any one of execution of power ON of the radio communication device 100, release of a state (a flight mode) in which some radio communication functions are limited, and a state (an out-of-service state) in which some frequency functions are not detectable. The predetermined state may be states other than the above states.

The frequency search is a process in which the radio communication device 100 searches for an available frequency or frequency band. When the radio communication device 100 uses the LTE, a LTE band is used. The LTE band is a frequency band available in the LTE. The frequency band used in LTE radio communication is defined by an organization 3GPP which performs standardization of radio communication methods. The technical specification “TS 36.101” of the 3GPP discloses a table of frequency bands named “E-UTRA operating bands”. Since the LTE band is plural, LTE band 1, LIE band 2, LTE band 3 and the like are defined. For example, operators of each country use some LTE bands. Herein, the frequency search may be performed in a cell search.

FIG. 6 is a diagram illustrating frequency bands available to the radio communication device 100 by a radio communication method. Each frequency band has a unique frequency width such that frequency band 1 has A (Hz) to B (Hz) and frequency band 2 has C (Hz) to D (Hz). In FIG. 6, country A uses frequency bands 1, 3, and 4. Furthermore, an operator X of the country A uses the frequency bands 1 and 3 used in the country A, and an operator Y of the country A uses the frequency bands 3 and 4 used in the country A.

Furthermore, the frequency search may be performed to search for a home frequency band, which is a frequency band corresponding to the home public land mobile network (HPLMN) indicating the network of the operator to which the user of the radio communication device 100 has originally subscribed, or a roaming frequency band in which roaming is possible. In addition, the frequency search may be performed to search for the home frequency band, the roaming frequency band, or other frequency bands.

For example, in FIG. 6, the user of the radio communication device 100 has made a contract with the operator X. Accordingly, the home frequency band of the radio communication device 100 is the frequency bands 1 and 3 and the roaming frequency band is the frequency bands 2 and 4; however, in the country A, since the frequency band 2 is not provided, the roaming frequency band is the frequency band 4.

In step S2, the radio communication device 100 may perform the frequency search for all frequency bands with which the radio communication device 100 is compatible. As a frequency band for which the frequency search is initially performed, a frequency band used just before by the radio communication device 100 may be set, that is, the frequency band is set such that the radio communication device 100 efficiently performs the frequency search.

Next, the radio communication device 100 determines whether an identifier (for example, a MCC as an identifier indicating a country number) received from a base station during the execution of the frequency search (step S2) matches an identifier (for example, a MCC as an identifier indicating a country number) indicating a service area of an operator stored in the storage unit 30 in advance (step S3). When a plurality of identifiers are received from one or a plurality of base stations, the radio communication device 100 determines whether any one of the plurality of identifiers matches the identifier indicating the service area of the operator stored in the storage unit 30 in advance.

Next, when it is determined in step S3 that the identifier received from the base station matches the identifier indicating the service area of the operator stored in the storage unit 30 in advance (step S3: YES), the radio communication device 100 excludes the roaming frequency band from a frequency search target (step S4). In this case, when the frequency search is performed later, since the roaming frequency band is excluded from the frequency search target, the radio communication device 100 searches for only the home frequency band. In this way, for example, when the radio communication device 100 is located in the country (when a MCC corresponding to domestic operator with which a user has made a contract is received), it is possible to omit to search for the roaming frequency band, so that it is possible to reduce power consumption due to a wasteful search.

Next, when it is determined in step S3 that the identifier received from the base station does not match the identifier indicating the service area of the operator stored in the storage unit 30 in advance (step S3: NO), the radio communication device 100 excludes the home frequency band from the frequency search target (step S5). In this way, for example, when the radio communication device 100 is located overseas (when it is not possible to receive a MCC corresponding to the operator with which the user has made a contract), it is possible to omit to search for the home frequency band, so that it is possible to reduce power consumption due to a wasteful search.

In addition, the radio communication device 100 may perform the matching determination of the identifier in step S3 before the frequency search in step S2. In such a case, the radio communication device 100 may exclude any one frequency from the target in step S4 or in step S5 and then perform the frequency search in step S2.

In step S4, the radio communication device 100 excludes the roaming frequency band from the frequency search target; however, instead, the radio communication device 100 may exclude a frequency band in which the identifier (for example, the MCC) indicating the service area of the operator stored in the storage unit 30 in advance is not managed. In such a case, in step S5, the radio communication device 100 excludes the home frequency band from the frequency search target; however, instead, the radio communication device 100 may employ, as the frequency search target, the frequency band in which the identifier (for example, the MCC) indicating the service area of the operator stored in the storage unit 30 in advance is not managed.

In step S4, when a base station corresponding to the HPLMN is found, the radio communication device 100 is connected to the base station. When the base station corresponding to the HPLMN is not found, the radio communication device 100 searches for the home frequency band or the roaming frequency band. That is, when a base station not corresponding to the HPLMN is found, the radio communication device 100 is temporarily connected to the base station.

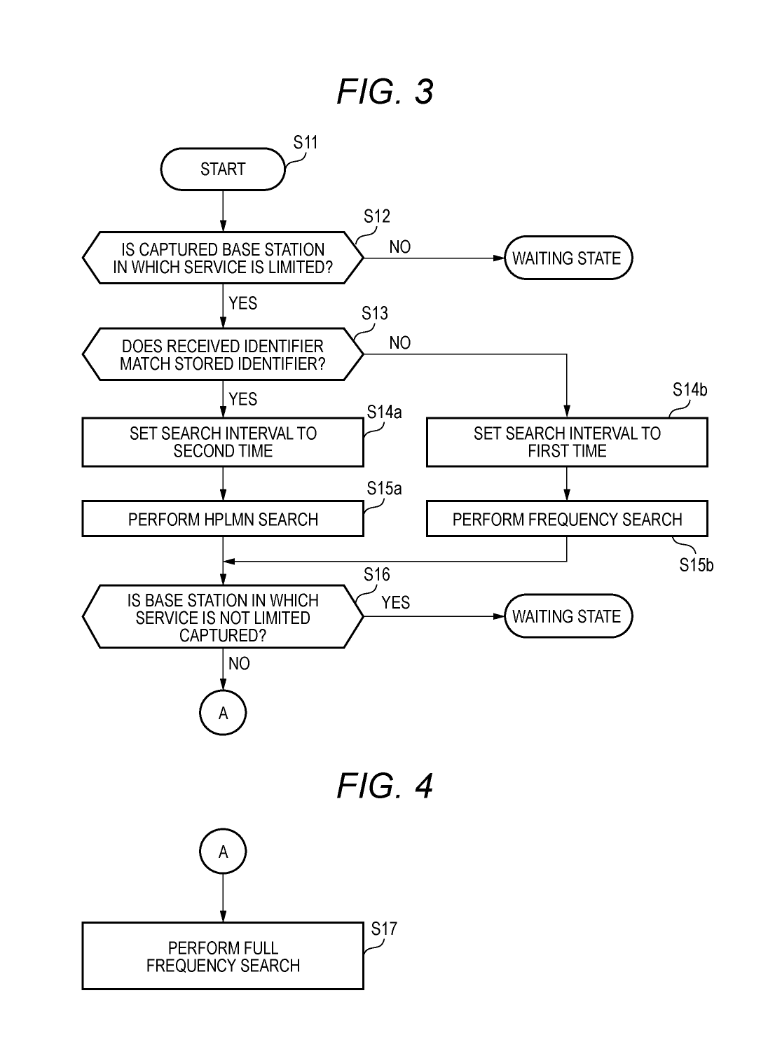

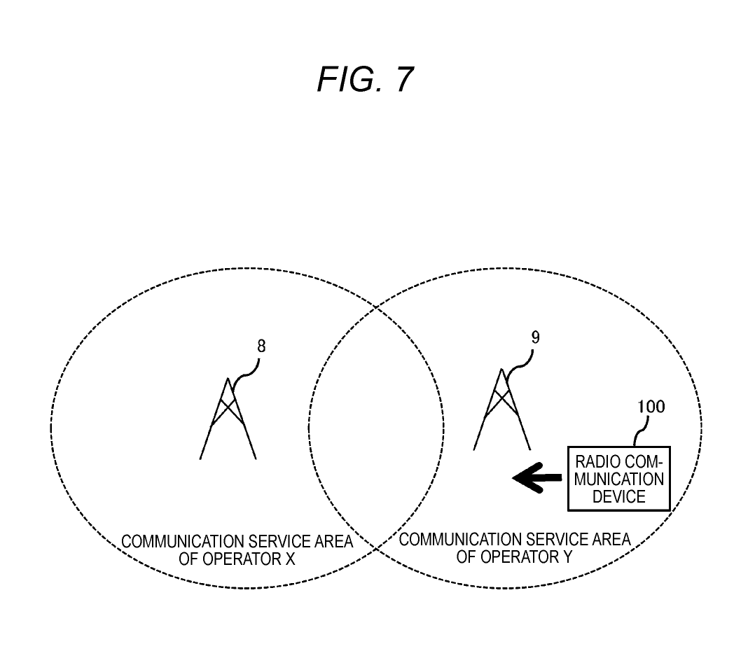

FIG. 7 is a diagram illustrating a state in which the radio communication device according to the embodiment is not located in a HPLMN communication service area. In this state, since the radio communication device 100 of the user, who has made a contract with the operator X, is located in the communication service area of the operator Y and is not located in a communication service area of the operator X, it is not possible to find a base station 8 of the operator X through the frequency search. However, as illustrated in FIG, 6, since the frequency band 3 is used in both the operator X and the operator Y, the radio communication device 100 can be connected to a base station 9 of the operator Y. However, when the radio communication device 100 moves in an arrow direction, the radio communication device 100 enters the communication service area of the operator X. Based on this, a control flow of the radio communication device 100 according to the embodiment will be described using FIG. 3.

First, when a base station (a cell) is captured (found) (step S11), the radio communication device 100 determines whether the captured base station is a base station in which a service used by the radio communication device 100 is limited or not (step S12).

The base station in which a service used by the radio communication device 100 is limited, for example, is an operator different from the operator with which the user has made a contract, and for example, is the base station 9 of the operator Y. Specifically, the base station in which a service is limited, indicates a base station in which the radio communication device 100 can use only a broadcast service of earthquake early warning and the like broadcasted from the base station and a limited service of an emergency call (emergency origination) and the like and is not able to use a normal communication service and data communication service.

When the captured base station is not the base station in which a service is limited (step S12: NO), the radio communication device 100 is transitioned to a waiting state (a state in which the radio communication device 100 makes synchronization with the base station and regularly receives a broadcast signal from the base station) and starts communication with the base station according to a predetermined trigger.

On the other hand, when the captured base station is the base station in which a service is limited (step S12: YES), the radio communication device 100 waits in the base station, but an available service is limited by the base station. Next, the radio communication device 100 determines whether an identifier (for example, the MCC as an identifier indicating a country number) received from the waiting base station matches the identifier (for example, the MCC as an identifier indicating a country number) indicating the service area of the operator stored in the storage unit 30 in advance (step S13).

When the identifier received from the waiting base station matches the identifier stored in the storage unit 30 (step S13: YES), the radio communication device 100 sets a frequency search interval to an interval (the second time) shorter than normal (step S14a), and performs a HPLMN search after the short interval passes from the start of a previous frequency search or the start of waiting (step S15a). In the HPLMN search, the radio communication device 100 attempts a frequency search in the frequency band identical to the frequency band connected to the base station in which the service is limited, and then performs the search in another home frequency band when a HPLMN base station is found.

For example, as described in FIG. 6 and FIG. 7, since the frequency band 3 is used in both the operators X and Y, there is a case where the radio communication device 100 is connected to the base station of the operator Y different from the operator X with which the user of the radio communication device 100 has made a contract. When the radio communication device 100 is connected to the base station of the operator Y, the radio communication device 100 sets the frequency search interval to the interval (the second time) shorter than normal.

In this way, for example, when the home frequency band includes the frequency band managed by another operator, there is an effect that waiting in the base station managed by the other operator is released and it is possible to early wait in the base station corresponding to the HPLMN.

On the other hand, when the identifier received from the waiting base station does not match the identifier stored in the storage unit 30 (step S13: NO), the radio communication device 100 sets the frequency search interval to the normal interval (the first time) (step S14b), and searches for the roaming frequency band after the normal interval passes from the start of the previous frequency search or the start of the waiting (step S15b).

For example, when the radio communication device 100 is located overseas, the radio communication device 100 sets the frequency search interval to the normal interval (the first time). In this way, there is an effective case where the radio communication device 100 performs the frequency search at the normal interval in a situation in which there is no HPLMN, power of the radio communication device 100 is not wastefully consumed.

Next, the radio communication device 100 determines whether the base station, in which the service is not limited, is captured or not (step S16). The base station, in which the service is not limited, indicates the base station in which the radio communication device 100 can not only use the broadcast service of earthquake early warning and the like broadcasted from the base station and the service of an emergency call (emergency origination) and the like, but also use the normal communication service and data communication service.

Next, when the base station, in which the service is not limited, is captured (step S16: YES), the radio communication device 100 waits in the base station.

On the other hand, when it is not possible to capture the base station in which the service is not limited (when the base station in which the service is limited is captured or when it is not possible to capture any base station) (step S16: NO), the radio communication device 100 performs a full frequency search as illustrated in FIG. 4 (step S17). In the full frequency search, a frequency band (B) provided in another radio communication method is searched in addition to all frequency bands (A) provided in a currently used radio communication method. Furthermore, only (A) may be searched or only (B) may be searched.

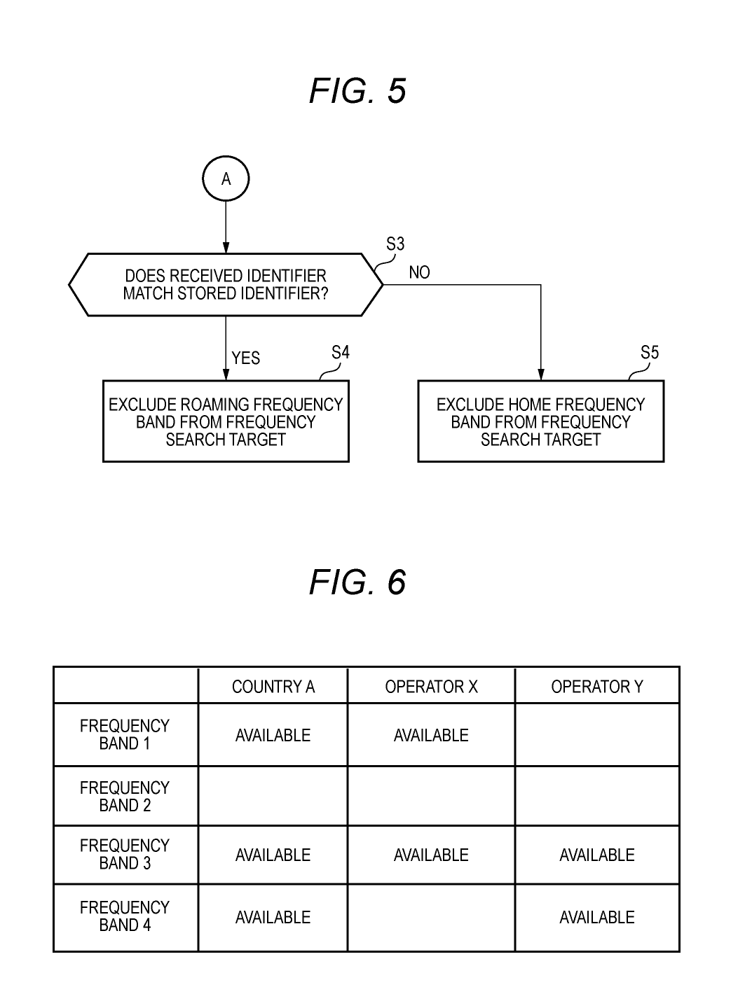

In another flow, when it is not possible to capture the base station in which the service is not limited (step S16: NO), the radio communication device 100 performs the flow illustrated in FIG. 5. It is noted that when the steps described in FIG. 2 are identical to those described in FIG. 5, the same reference numerals are given. The radio communication device 100 determines whether an identifier received from the base station matches the identifier indicating the service area of the operator stored in the storage unit 30 in advance or not (step S3).

Next, when it is determined in step S3 that the identifier received from the base station matches the identifier indicating the service area of the operator stored in the storage unit 30 in advance (step S3: YES), the radio communication device 100 excludes the roaming frequency band from a frequency search target (step S4). When it is determined in step S3 that the identifier received from the base station does not match the identifier indicating the service area of the operator stored in the storage unit 30 in advance (step S3: NO), the radio communication device 100 excludes the home frequency band from the frequency search target (step S5).

So far, although the embodiment has been described, this disclosure is not limited to the embodiment. Furthermore, the effects described in the embodiment are merely the most preferred effects acquired from this disclosure, and the effects of this disclosure are not limited to those described in the aforementioned embodiment.

It is noted that the radio communication device according to the embodiment includes at least a mobile phone, a portable personal computer, a digital camera, a media player, an electronic book reader, a navigator, a portable electronic device such as a game device, a module dedicated for communication specialized in a communication function, a desktop computer, a stationary electronic device such as a television receiver, and the like.

This application is based upon Japanese Patent Application (Japanese Patent Application No. 2016-029249) filed on Feb. 18, 2016, the entire contents of which are incorporated by citation.

### INDUSTRIAL APPLICABILITY

According to the radio communication device of this disclosure, it is possible to perform an efficient frequency search.

### REFERENCE SIGNS LIST

10: control unit

20: communication unit

30: storage unit

100: radio communication device

8, 9: base station

1. A radio communication device comprising:
a storage unit that stores identification information for identifying a service area of a home network to which a user subscribed originally;
a communication unit that performs radio communication by using a frequency band of a radio communication, with which the radio communication device of the user is compatible; and
a control unit that, at a time when a search for the frequency band of the radio communication method is performed using the communication unit or before the search is performed, performs the search with excluding a roaming frequency band, in which roaming is possible, from the frequency band of the radio communication method if the identification information stored in the storage unit matches identification information acquired from a base station.

2. The radio communication device according to claim 1, wherein
the control unit, if the identification information stored in the storage unit does not match the identification information acquired from the base station, performs the search with excluding a frequency band of the home network to which the user subscribed originally from the frequency band of the radio communication method.

3. The radio communication device according to claim 1, wherein
when the radio communication device is connected to a base station of a network to which the user does not originally subscribe, the control unit:
performs, if the identification information stored in the storage unit does not match the identification information acquired from the base station, the search at a first time interval, and
performs, if the identification information stored in the storage unit matches the identification information acquired from the base station, the search at a second time interval,
wherein the second time is shorter than the first time.

4. The radio communication device according to claim 3, wherein
after the search, the control unit, when the radio communication device is not connected to a base station of the home network to which the user subscribed originally, searches for a frequency band including the roaming frequency band and a frequency band of the home network to which the user subscribed originally.

5. The radio communication device according to claim 3, wherein
after the search, if the identification information stored in the storage unit matches the identification information acquired from the base station, the control unit performs the search with excluding the roaming frequency band from the frequency band of the radio communication method.

6. The radio communication device according to claim 1, wherein
when power-on of the radio communication device, power-on of a radio communication function, or the frequency band of the radio communication method is not detectable, the control unit performs the search.

7. A radio communication device comprising:
a communication chip that performs radio communication by using a frequency band of a radio communication method, with which the radio communication device of the user is compatible; and
a controller that, at a time when a search for the frequency band of the radio communication method is performed or before the search is performed, performs the search with excluding a roaming frequency band, in which roaming is possible, from the frequency band of the radio communication method if the radio communication device is located in an area managed by a home network to which the user subscribed originally.

8. A method of controlling a radio communication device having identification information for identifying a service area of a home network to which a user subscribed originally, the method comprising:
performing radio communication by using a frequency band of a radio communication, with which the radio communication device of the user is compatible, and
performing, at a time when a search for the frequency band of the radio communication method is performed using the communication unit or before the search is performed, the search with excluding a roaming frequency band, in which roaming is possible, from the frequency band of the radio communication method if the identification information stored in the storage unit matches identification information acquired from a base station.
